(19) United States
(12) Patent Application Publication
(10) Pub. No.: US 2006/0061432 A1
(43) Pub. Date: Mar. 23, 2006

(54) Two-layer PCB with impedence control and method of providing the same

(75) Inventors: Shou-Kuo Hsu, Tu-Cheng (TW); Yu-Chang Pai, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/225,663

(22) Filed: Sep. 12, 2005

(30) Foreign Application Priority Data
Sep. 22, 2004 (CN) 200410051675.5

(51) Int. Cl. H01P 5/02

(52) U.S. Cl. 333/33

(57) ABSTRACT

A two-layer printed circuit board (PCB) having impedance control is provided. The two-layer PCB includes: a substrate; a plurality of transmission lines laid on the substrate for transmitting high-speed signals, each of the transmission lines having a standard impedance; and at least one ground trace laid on the substrate adjacent each of the transmission lines, for controlling a characteristic impedance of each of the transmission lines to equal or approach the standard impedance.

### BACKGROUND OF THE INVENTION

1. Field of the Invention

The present invention relates to a printed circuit board, and particularly to a two-layer printed circuit board achieving impedance control and a method of achieving impedance control when high-speed signal transmission lines are laid on the two-layer printed circuit board.

2. Background

Signal integrity is an important factor to be taken into account when a printed circuit board (PCB) is designed. A well-designed PCB has an elevated on-off switching speed of integrated circuits, and a high density, compact layout of components. Parameters of the components and of the PCB substrate, a layout of the components on the PCB, and a layout of high-speed signal transmission lines all have an impact on signal integrity. In turn, proper signal integrity helps the PCB and an associated computer system to achieve stable performance. Impedance matching is considered as an important part of signal integrity. Therefore a characteristic impedance of a transmission line is designed to match an impedance of a load associated with the transmission line. If the characteristic impedance of the transmission line is mismatched with the impedance of the load, signals arriving at a receiving terminal are apt to be partially reflected, causing a waveform of the signals to distort, overshoot, or undershoot. Signals that reflect back and forth along the transmission line causing “ringing.”

Parameters that have an impact on the impedance of the transmission line include a width and a thickness of a copper wire or trace of the transmission line, a dielectric constant and a thickness of a substrate of the PCB, and a thickness of each of a bonding pad, a trace of a ground wire, and other peripheral traces. An experiential formula used to calculate the impedance of a transmission line is as follows:

$${Z}_{0} \approx \frac{87}{\sqrt{{ɛ}_{r} + 1.41}} ln \frac{5.98 H}{0.8 W + t}$$

Where Z₀ is the characteristic impedance of the transmission line, εᵣ is the dielectric constant of an associated PCB substrate, W is the width of the transmission line, t is the thickness of the transmission line, and H is the thickness of the substrate. A four-layer PCB achieves impedance control via a framework that includes the transmission line and a reference ground plane adjacent the transmission line. Referring to FIG. 1, the four-layer PCB includes transmission lines 100, substrates 110, 130, and two ground layers 120. According to the standard dimensions of PCB manufacturing, H is 4.4 mil, t is 2.1 mil, and εᵣ is 4 for a standard 4 layer structure. If a width of the transmission line is 5 mil, the impedance of the transmission line is 54.7 ohms. This figure approaches a standard value for achieving impedance matching; that is, 60 ohms. In addition, simulation software is also available to calculate the impedance of the transmission line. A section plan of the transmission line, the substrates, and the ground layers are inputted to simulation software. Then simulation software analyses an electromagnetic field caused by the transmission line and the ground layers, and calculates the impedance of the transmission line.

A two-layer PCB used for an input/output card is manufactured without ground layers in the substrate, in order to achieve reduced costs. However, a layout of the conventional two-layer PCB is not standardized. Generally a relatively large unused area of the PCB has copper applied thereto, which serves as ground. Therefore impedance matching is hard to achieve. FIG. 2 shows the conventional two-layer PCB. The two-layer PCB includes a transmission line 150, a ground layer 160, and a substrate 170. A thickness of the substrate 150 is 56 mil. If a width of the transmission line 150 is 5 mil, a value of a characteristic impedance of the transmission line 150 is calculated to be 150 ohms. If the characteristic impedance of the transmission line 150 is to approach a standard impedance of 60 ohms, the width of the transmission line 150 would need to be 82 mil, which is a most unreasonable requirement. When using simulation software, it is hard to control the characteristic impedance of each of the transmission lines 150, because the section plan includes a plurality of transmission lines 150 and only one ground layer 160 to refer thereto.

What is needed, therefore, is a two-layer PCB which is able to achieve impedance control with a reasonable layout. What is also needed is a method for achieving such impedance control.

### SUMMARY

A two-layer printed circuit board (PCB) having impedance control is provided. In a preferred embodiment, the two-layer PCB includes: a substrate; a plurality of transmission lines laid on the substrate for transmitting high-speed signals, each of the transmission lines having a standard impedance; and at least one ground trace laid on the substrate adjacent each of the transmission lines, for controlling a characteristic impedance of each of the transmission lines to equal or approach the standard impedance. Hence, the impedance of the transmission lines is calculable without any necessary integral metal plane (grounded or powered) forming in the PCB.

A method of providing impedance control for a two-layer printed circuit board is also disclosed. The two-layer PCB includes a substrate and a plurality of transmission lines laid on the substrate for transmitting high-speed signals. The method comprises the steps of: (a) laying at least one ground trace on the substrate adjacent each of the transmission lines; (b) inputting a section plan of the two-layer PCB to simulation software; (c) calculating a characteristic impedance of each of the transmission lines via the simulation software; (d) comparing the characteristic impedance calculated in step (c) with a standard impedance; (e) if the characteristic impedance calculated in step (c) does not equal or approach the standard impedance, adjusting any one or more of parameters of the section plan, and returning to step (b); and (f) if the characteristic impedance calculated in step (c) equals or approaches the standard impedance, performing a layout of each of the transmission lines and the ground trace according to the last-input parameters.

The two-layer PCB is capable of achieving impedance control of each of the transmission lines, so as to achieve signal integrity for the two-layer PCB.

Other advantages and novel features will become more apparent from the following detailed description of preferred embodiments when taken in conjunction with the accompanying drawings, in which:

### BRIEF DESCRIPTION OF THE DRAWINGS

FIG. 1 is a section plan of a conventional four-layer PCB;

FIG. 2 is a section plan of a conventional two-layer PCB;

FIG. 3 is a section plan of a two-layer PCB in accordance with a first preferred embodiment of the present invention; and

FIG. 4 is a section plan of a two-layer PCB in accordance with a second preferred embodiment of the present invention.

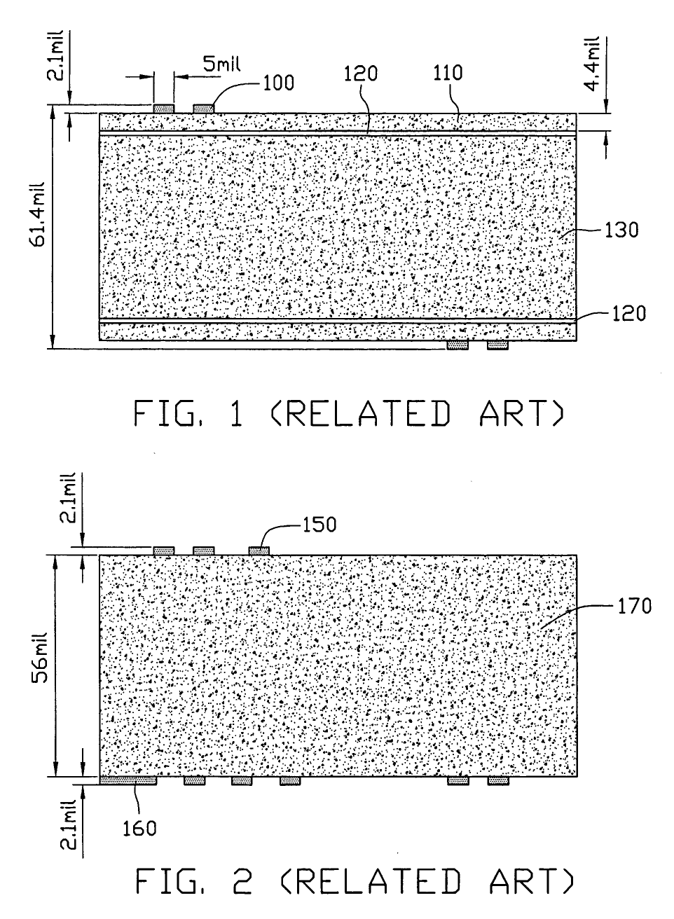

### DETAILED DESCRIPTION OF THE EMBODIMENTS

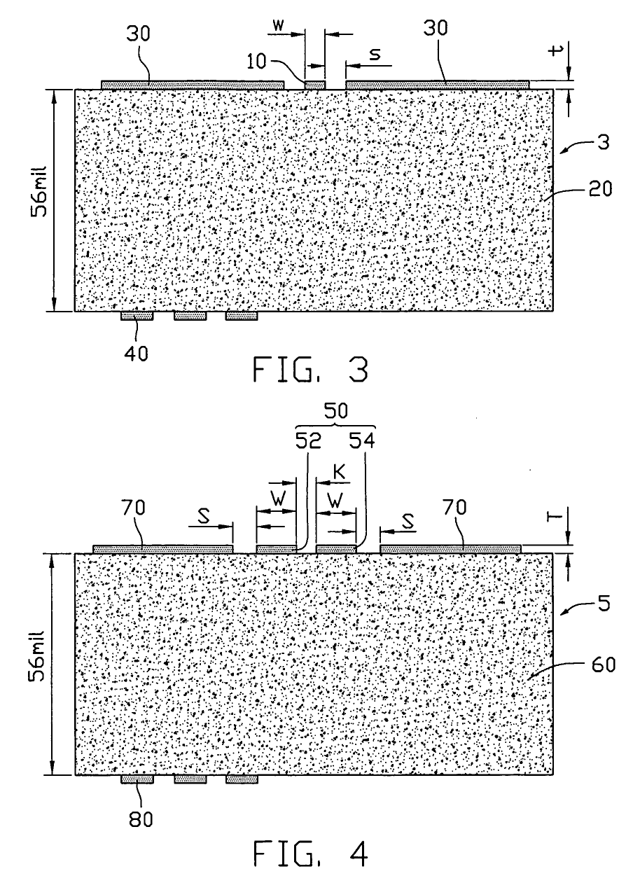

FIG. 3 shows a section plan of a two-layer PCB in accordance with a first preferred embodiment of the present invention. The two-layer PCB 3 includes a plurality of single transmission lines for transmitting high-speed signals. The two-layer PCB 3 includes a single transmission line 10, a substrate 20, two ground traces 30, and a plurality of low-speed signal transmission lines 40. The ground traces 30 and the single transmission line 10 are laid on a same plane level of the substrate 20 side by side, with the ground traces 30 being adjacent opposite sides of the single transmission line 10 respectively. A thickness of the ground traces is equal to a thickness of the single transmission line 10, the thicknesses generally being 2.1 mil. In order to control the impedance of the single transmission line 10, the section plan as shown in FIG. 3 is inputted to simulation software, such as a 2D Extractor. Simulation software analyses an electromagnetic field caused by components of the section plan, and calculates a value of the characteristic impedance of the single transmission line 10. If the calculated value does not equal or approach a required standard value for the two-layer PCB 3, one or more of the following parameters are adjusted: a width w and a thickness t of the single transmission line 10, and a spacing s between the single transmission line 10 and each of the ground traces 30. Then another section plan defined by the adjusted parameters is inputted to simulation software, and the characteristic impedance of the single transmission line 10 is recalculated. Such processes are repeated if necessary until the calculated value equals or approaches the standard value, thus obtaining a group of proper parameters including w, s, and t, which achieve the desired impedance matching. Then the layout of the single transmission line 10 and the two ground traces 30 is performed according to the proper parameters.

If only one ground trace 30 is laid adjacent only one side of the single transmission line 10, parameters achieving the desired impedance matching can also be obtained via simulation software. Using only one ground trace 30 is simple and inexpensive. However, in the first preferred embodiment using two ground traces 30 respectively laid adjacent opposite sides of the single transmission line 10, the single transmission line 10 is more effectively insulated from other transmission lines. Besides, the impedance of the transmission lines is calculable without any necessary integral metal plane (grounded or powered) forming in the PCB.

FIG. 4 shows a section plan of a two-layer PCB in accordance with a second preferred embodiment of the present invention. The two-layer PCB 5, applied to transmit USB (Universal Serial Bus) 2.0 signals, includes a differential transmission line 50 for transmitting high-speed signals, a substrate 60, two ground traces 70, and a plurality of low-speed signal transmission lines 80. The differential transmission line 50 includes two componential transmission lines 52 and 54. The transmission lines 52 and 54 are uniformly spaced apart, have a same length, and transmit signals in mutually opposite directions. The ground traces 70 and the differential transmission line 50 are laid on the substrate 60 side by side, with the ground traces 70 being adjacent opposite sides of the differential transmission line 50 respectively. A thickness of the ground traces 70 is equal to a thickness of the differential transmission line 50, the thicknesses generally being 2.1 mil. In order to control the impedance of the differential transmission line 50, the section plan as shown in FIG. 4 is inputted to simulation software. Simulation software analyses an electromagnetic field caused by components of the section plan, and calculates a value of the characteristic impedance of the differential transmission line 50. If the calculated value does not equal or approach a required standard value for the two-layer PCB 5, one or more of the following parameters are adjusted: a width W and a thickness T of the differential transmission line 50, a spacing K between the transmission lines 52 and 54, and a spacing S between the differential transmission line 50 and each ground trace 30. Then another section plan defined by the adjusted parameters is inputted to simulation software, and the characteristic impedance of the differential transmission line 50 is recalculated. Such processes are repeated if necessary until the calculated value equals or approaches the standard value, thus obtaining a group of proper parameters including W, S, K, and T, which achieve the desired impedance matching. Then the layout of the differential transmission line 50 and the two ground traces 70 is performed according to the proper parameters.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A two-layer printed circuit board (PCB) with impedance control, comprising:
a substrate;
a plurality of transmission lines laid on the substrate for transmitting high-speed signals, each of the transmission lines having a standard impedance; and
at least one ground trace laid on the substrate adjacent each of the transmission lines, for controlling a characteristic impedance of each of the transmission lines to equal or approach the standard impedance.

2. The two-layer PCB as claimed in claim 1, wherein the transmission lines are single transmission lines.

3. The two-layer PCB as claimed in claim 2, wherein two ground traces are laid adjacent respective opposite sides of each of the single transmission lines.

4. The two-layer PCB as claimed in claim 2, wherein one ground trace is laid adjacent one side of each of the single transmission lines.

5. The two-layer PCB as claimed in claim 1, wherein the transmission lines are differential transmission lines.

6. The two-layer PCB as claimed in claim 5, wherein two ground traces are laid adjacent respective opposite sides of each of the differential transmission lines.

7. The two-layer PCB as claimed in claim 1, wherein the characteristic impedance of each of the transmission lines is determined by one or more parameters selected from the group consisting of: a thickness of each of the transmission lines, a width of each of the transmission lines, and a spacing between each of the transmission lines and the ground trace.

8. A method of providing impedance control for a two-layer printed circuit board (PCB), the two-layer PCB comprising a substrate and a plurality of transmission lines laid on the substrate for transmitting high-speed signals, the method comprising the steps of:
(a) laying at least one ground trace on the substrate adjacent each of the transmission lines;
(b) inputting a section plan of the two-layer PCB to simulation software;
(c) calculating a characteristic impedance of each of the transmission lines via the simulation software;
(d) comparing the characteristic impedance calculated in step (c) with a standard impedance;
(e) if the characteristic impedance calculated in step (c) does not equal or approach the standard impedance, adjusting any one or more of parameters of the section plan, and returning to step (b); and
(f) if the characteristic impedance calculated in step (c) equals or approaches the standard impedance, performing a layout of each of the transmission lines and the ground trace according to the last-input parameters.

9. The method as claimed in claim 8, wherein the parameters comprise any one or more of a thickness of each of the transmission lines, a width of each of the transmission lines, and a spacing between each of the transmission lines and the ground trace.

10. A method to control impedance of a printed circuit board, comprising the steps of:
locating a transmission line on a substrate of a printed circuit board (PCB) to be impedance controlled;
providing at least one ground trace neighboring said transmission line on a same plane level of said substrate;
calculating characteristic impedance of said transmission line according to related parameters of said transmission line and said at least one ground trace;
evaluating satisfaction of said calculated characteristic impedance of said transmission line with respect to related standards of said PCB;
adjusting at least one of said related parameters when said calculated characteristic impedance is dissatisfactory; and
repeating steps from said calculating step to said adjusting step to meet said standards of said PCB.

11. The method as claimed in claim 10, wherein said parameters include a width value and a thickness value of said transmission line, a spacing value between componential transmission lines of said transmission line, and a spacing value between said transmission line and said at least one ground trace.

12. The method as claimed in claim 10, wherein said PCB is a two-layer printed circuit board without any integral metal plane formed therein.
